(19) United States
(12) Patent Application Publication
(10) Pub. No.: US 2008/0169760 A1
(43) Pub. Date: Jul. 17, 2008

(54) Plasma display panel comprising single barrier ribs and double barrier ribs

(76) Inventor: Jung-Suk Song, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/784,345

(22) Filed: Apr. 6, 2007

(30) Foreign Application Priority Data
Jan. 17, 2007 (KR) 10-2007-0005444

(51) Int. Cl. H01J 17/49

(52) U.S. Cl. 313/582; 313/583; 313/584

(57) ABSTRACT

A plasma display panel capable of minimizing power consumption and maximizing a brightness is provided. The plasma display panel includes a front substrate and a rear substrate arranged to face each other, a plurality of horizontal ribs defining a discharge space between the front and rear substrates, the horizontal ribs comprising single barrier ribs and double barrier ribs, a plurality of vertical ribs arranged perpendicularly to the horizontal ribs to define the discharge space into a plurality of discharge cells, and a plurality of pairs of discharge electrodes to which a voltage is applied so that a discharge is generated within the discharge cells.

### CROSS-REFERENCE TO RELATED PATENT APPLICATION

This application claims the benefit of Korean Patent Application No. 10-2007-0005444, filed on Jan. 17, 2007, in the Korean Intellectual Property Office, the disclosure of which is incorporated herein in its entirety by reference.

### BACKGROUND OF THE INVENTION

1. Field of the Invention

The present embodiments relate to a plasma display panel including single barrier ribs and double barrier ribs.

2. Description of the Related Art

In general plasma display panels, barrier ribs are arranged between a front panel and a rear panel define a plurality of discharge cells. Also, a phosphor material is coated on the barrier ribs and each of the discharge cells is filled with a main discharge gas, such as Ne, He, or a mixture of Ne and He, and an inert gas including a small amount of xenon (Xe). Such plasma display panels display images by applying a high frequency voltage to the discharge cells to generate vacuum ultraviolet rays from an inert gas and exciting a phosphor material with the vacuum ultraviolet rays. Such plasma display panels are spotlighted as next-generation display devices because they can be manufactured to be thin and light.

Brightness, which is an important evaluating factor of plasma display panels, represents the brightness of a screen. The brightness is classified into a full white brightness that represents the brightness of an entirely white screen, and a 1% peak brightness that represents the brightness of a 1%-white screen.

The full white brightness is closely related to power consumption. More specifically, the greater the full white brightness is, the smaller the power consumption is. Therefore, in order to improve the brightness while minimizing power consumption, a plasma display panel with both an improved 1% peak brightness and an improved full white brightness would be advantageous.

### SUMMARY OF THE INVENTION

The present embodiments provide a plasma display panel capable of maximizing brightness by improving both 1% peak brightness and full white brightness and of minimizing power consumption.

According to an aspect of the present embodiments, there is provided a plasma display panel including a front substrate and a rear substrate arranged to face each other, a plurality of horizontal ribs defining a discharge space between the front and rear substrates, the horizontal ribs including single barrier ribs and double barrier ribs, a plurality of vertical ribs arranged perpendicularly to the horizontal ribs to define the discharge space into a plurality of discharge cells, and a plurality of pairs of discharge electrodes to which a voltage is applied so that a discharge is generated within the discharge cells.

The discharge cells may include first discharge cells and second discharge cells wider than the first discharge cells. The first discharge cells may be defined by the double barrier ribs, and the second discharge cells may be defined by the single barrier ribs, so that the discharge cells may have different widths.

The horizontal ribs may be parallel to one another. At least one of the horizontal ribs may include both double barrier ribs and single barrier ribs.

The discharge cells may include first discharge cells and second discharge cells that have higher brightness than the first discharge cells. The first discharge cells may be defined by the double barrier ribs, and the second discharge cells may be defined by the single barrier ribs, so that the second discharge cells having higher brightness are wider than the first discharge cells having lower brightness. Thus, the brightness of the plasma display panel is increased.

The discharge cells include red discharge cells, green discharge cells, and blue discharge cells according to the type of a phosphor material. Generally, since the green discharge cells have higher brightness than the other discharge cells, the green discharge cells are formed to be wider than the other discharge cells. In other words, the green discharge cells may be defined by the single barrier ribs.

The discharge electrodes may include transparent electrodes and bus electrodes. The bus electrodes are arranged over the double barrier ribs, such that the aperture ratio of the plasma display panel can be increased.

The bus electrodes are straight lines, so that only the double barrier ribs but the single barrier ribs may be covered with the bus electrodes.

The discharge cells may include the red discharge cells, the green discharge cells, and the blue discharge cells. Generally, since the green discharge cells have higher rightness than the other discharge cells, the green discharge cells are formed to be wider than the other discharge cells. Accordingly, the green discharge cells are defined by the single barrier ribs. The bus electrodes have straight-line shapes, such that they may be arranged over the double barrier ribs and the green discharge cells.

The discharge electrodes include X electrodes and Y electrodes to which voltages are alternately applied. The X electrodes includes X transparent electrodes and X bus electrodes. The Y electrodes include Y transparent electrodes and Y bus electrodes. The Y electrodes can apply different voltages to the discharge cells, whereas the X electrodes can apply a common voltage to the discharges. Accordingly, the X electrodes may be integrally formed, and may be arranged over the double barrier ribs and single barrier ribs of the horizontal ribs in order to improve the aperture ratio of the plasma display panel.

Particularly, the X bus electrodes may be arranged over the double barrier ribs and the single barrier ribs of the horizontal ribs but not over non-discharge areas defined by the double barrier ribs. Accordingly, the X bus electrodes may be formed in the same pattern as that of the horizontal ribs.

The X electrodes may be arranged over the double barrier ribs and single barrier ribs of the horizontal ribs and the non-discharge areas defined by the double barrier ribs. Accordingly, the X bus electrodes may have dumbbell shapes that have first areas arranged over the single barrier ribs and second areas arranged over the double barrier ribs and the non-discharge areas so as to have a greater width than the first areas.

The plasma display panel further includes upper dielectric layer formed on the front substrate to prevent the discharge electrodes from being damaged by charge particles and to induce charges.

The upper dielectric layer includes first upper dielectric layers and second upper dielectric layers that have different dielectric constants. The second upper dielectric layers have a higher dielectric constant than the first upper dielectric layers and are arranged over discharge cells that are relatively wide. In other words, the second upper dielectric layers are arranged over the second discharge cells defined by the single barrier ribs.

The discharge cells include the red discharge cells, the green discharge cells, and the blue discharge cells. In this case, since the green discharge cells have higher rightness than the other discharge cells, the green discharge cells are defined by the single barrier ribs and thus formed to be wider than the other discharge cells. Accordingly, the second upper dielectric layers have a higher dielectric constant than the first upper dielectric layers, and the second upper dielectric layers are arranged over the green discharge cells.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a plasma display panel according to an embodiment;

FIG. 2 is a plan view of a lower panel of the plasma display panel shown in FIG. 1;

FIG. 3 is a plan view of the lower panel of the plasma display panel shown in FIG. 1 over which discharge electrodes are arranged;

FIG. 4 is a plan view of a lower panel of a plasma display panel according to another embodiment over which discharge electrodes are arranged;

FIG. 5 is a plan view of a lower panel of a plasma display panel over which discharge electrodes are arranged, according to another embodiment;

FIG. 6 is an exploded perspective view of a plasma display panel according to another embodiment; and

FIG. 7 is a cross-section of the plasma display panel shown in FIG. 6.

### DETAILED DESCRIPTION OF THE INVENTION

The present embodiments will now be described more fully with reference to the accompanying drawings, in which exemplary embodiments are shown.

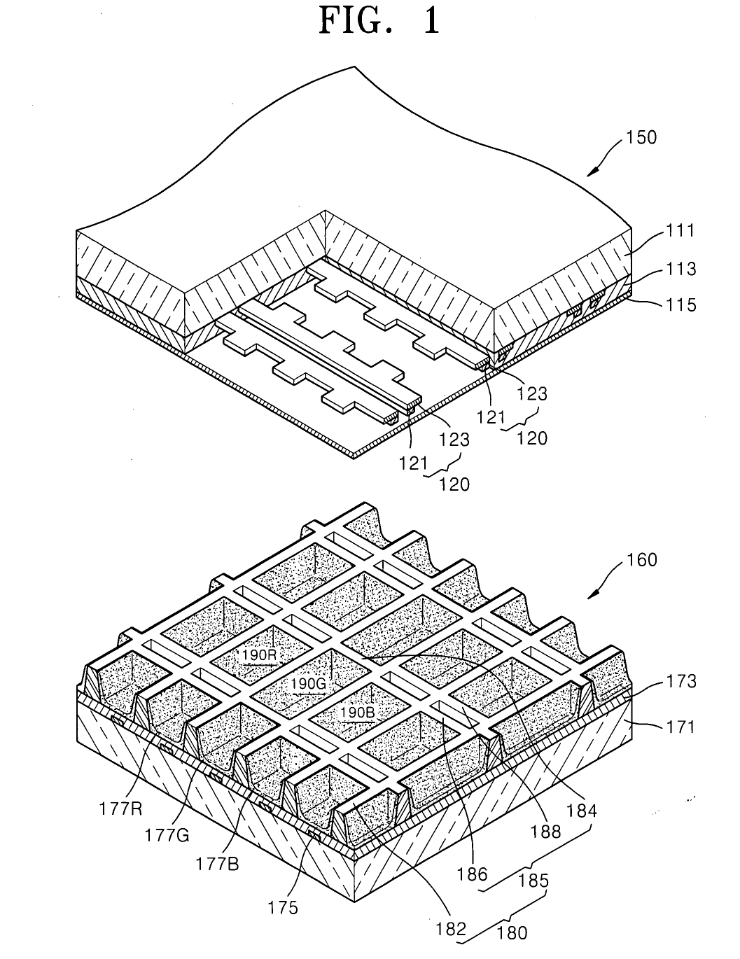

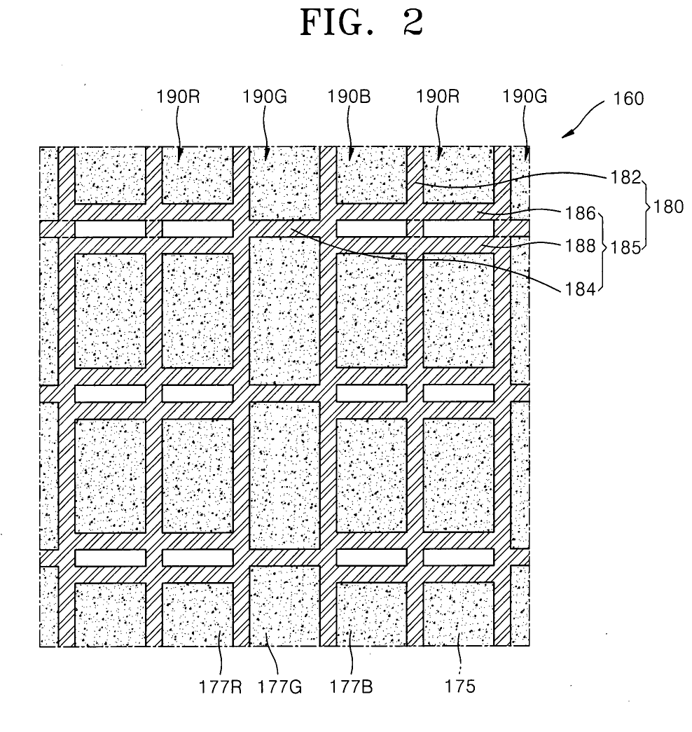

FIG. 1 is an exploded perspective view of a plasma display panel according to an embodiment. FIG. 2 is a plan view of a bottom panel 160 of the plasma display panel shown in FIG. 1.

Referring to FIG. 1, the plasma display panel includes an upper panel 150 and a lower panel 160.

The upper panel 150 includes an upper substrate 111, a plurality of discharge electrodes 120 arranged parallel to one another on the upper substrate 111, and an upper dielectric layer 113 formed on the upper substrate 111 and covering the discharge electrodes 120. A protection layer 115 is formed on the upper dielectric layer 113.

The upper substrate 111 may be formed of a highly optical transmissive material, such as glass, as a main component.

The discharge electrodes 120 include wide transparent electrodes 123 that transmit light, and bus electrodes 121 having high electrical conductivity.

The upper dielectric layer 113 prevents the discharge electrodes 120 from being damaged by charged particles, and induces charges to thereby facilitate the generation of discharge.

The protection layer 115 prevents the upper dielectric layer 113 from being damaged by charged particles, and increases the secondary electron emission efficiency. The protection layer 115 may be formed of, for example, magnesium oxide (MgO).

To form the lower panel 160, a plurality of address electrodes 175 are arranged on a lower substrate 171 intersecting the discharge electrodes 120. A lower dielectric layer 173 is formed on the lower substrate 171 and covers the address electrodes 175. A barrier structure 180 defining a plurality of discharge cells is formed on the lower dielectric layer 173.

Like the upper substrate 111, the lower substrate 171 may be formed of a highly optical transmissive material, such as glass as a main component, and may be colored to improve a bright room contrast.

The barrier structure 180 includes vertical ribs 182 substantially parallel to the address electrodes 175, and horizontal ribs 185 intersecting the vertical ribs 182.

Referring to FIGS. 1 and 2, the horizontal ribs 185 include single barrier ribs 184 and double barrier ribs 186 and 188. Discharge cells are defined on both sides of each single barrier rib 184. Each double barrier rib includes a first double barrier rib 186 and a second double barrier rib 188. Discharge cells are defined on outer sides of the first and second double barrier ribs 186 and 188, and non-discharge areas are formed between inner sides of the first and second double barrier ribs 186 and 188. The non-discharge areas are used as the path of an exhaust gas, so that the exhaust gas can be effectively discharged.

The single barrier ribs 184 define green discharge cells 190G, and the double barrier ribs 186 and 188 define red discharge cells 190R and blue discharge cells 190B. Accordingly, the green discharge cells 190G have wider discharge spaces than the red discharge cells 190G and the blue discharge cells 190B. Generally, the green discharge cells 190G provide high brightness, and thus, when the green discharge cells 190G are wide, the entire brightness can increase.

As described above, the horizontal ribs 185 including the single barrier ribs 184 and the double barrier ribs 186 and 188 may be formed by attaching a pre-patterned sheet to the lower dielectric layer 173 or by using an etching method.

Phosphor layers are formed on the barrier ribs 180. The vertical ribs 182 and the single barrier ribs 184 of the horizontal ribs 185 have phosphor layers coated on both sides thereof, whereas the double barrier ribs 186 and 188 have phosphor layers coated on only one side thereof. In the present embodiment, green phosphor layers 177G are coated on both sides of the single barrier ribs 184, and red phosphor layers 177R or blue phosphor layers 177B are coated on one side of the double barrier ribs 186 and 188. Since the green discharge cells 190G defined by the single barrier ribs 184 are wider than the red discharge cells 190R and the blue discharge cells 190B, the green phosphor layers 177G are wider than the red and blue phosphor layers 177R and 177B.

An inert mixed gas, such as, for example, He gas and Xe gas, Ne gas and Xe gas, or He gas, Ne gas and Xe gas, is injected into the discharge cells 190R, 190G, and 190B defined by the barrier structure 180.

An experiment for measuring a 1% peak brightness and a full white brightness was conducted, in which the plasma display panel according to the present embodiment having the horizontal ribs 185 made up of both the single barrier ribs 184 and the double barrier ribs 186 and 188 was used as an experimental group, a plasma display panel having horizontal ribs made up only of single barrier ribs was used as Comparative Group 1, and a plasma display panel having horizontal ribs made up only of double barrier ribs was used as Comparative Group 2. The plasma display panels corresponding to Comparative Groups 1 and 2 have a matrix-type barrier structure as the plasma display panel according to the present embodiment.

1% peak brightnesses are the brightnesses obtained and measured when the plasma display panels are driven such that a center portion of the screen corresponding to only 1% of the entire area of the screen is represented with white and the other area is represented with a dark color.

Full white brightnesses are brightnesses obtained and measured when the plasma display panels are driven such that the entire screen is represented with white.

Referring to Table 1 below, the 1% peak brightness of Comparative Group 1 including only single barrier ribs is 1176 cd/m², which is higher than that (i.e., 1054 cd/m²) of Comparative Group 2. The full white brightness of Comparative Group 1 is 147 cd/m², which is lower than that (i.e., 165 cd/m²) of Comparative Group 2. Hence, Comparative Group 1 having only single barrier ribs has a relatively high 1% peak brightness but a relatively low full white brightness, leading to high power consumption. Comparative Group 2 having only double barrier ribs has a higher full white brightness and thus consumes small power, but has a lower 1% peak brightness leading to a low overall brightness.

However, the experimental group being the plasma display panel including the horizontal ribs 185 made up of both the single barrier ribs 184 and the double barrier ribs 186 and 188 has a 1% peak brightness almost the same as that of Comparative Group 1 and a full white brightness almost the same as that of Comparative Group 2. That is, the experimental group has a 1% peak brightness and a full white brightness both being nearly equal to the highest brightnesses. Accordingly, the plasma display panel according to the present embodiment minimizes power consumption and maximizes the entire brightness by including the horizontal ribs 185 made up of both the single barrier ribs 184 and the double barrier ribs 186 and 188.

TABLE 1

| | Comparative | Comparative | |
|---|---|---|---|
| Items | Group 1 | Group 2 | Experimental Group |
| 1% peak brightness | 1176 | 1054 | 1140 |
| (cd/m²) | | | |
| Full white | 147 | 165 | 160 |
| brightness (cd/m²) | | | |

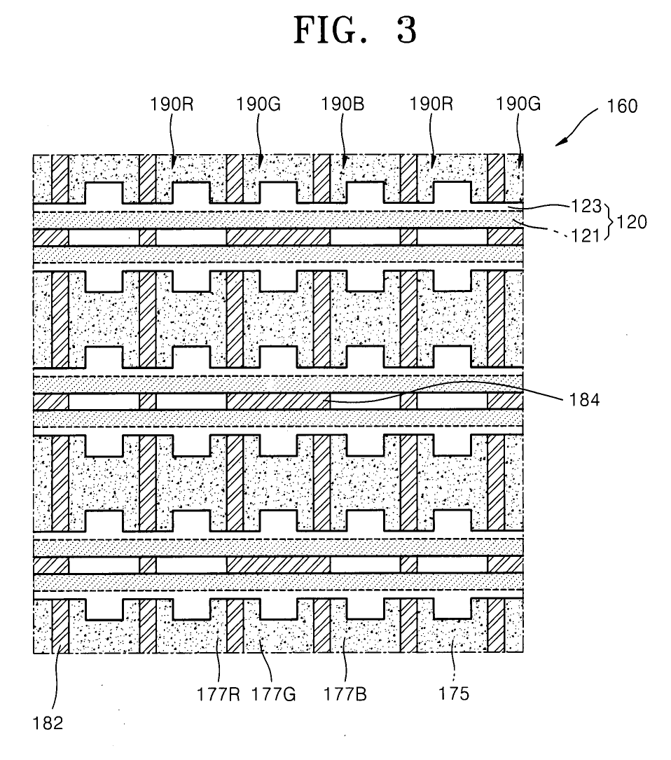

FIG. 3 illustrates the lower panel 160 of the plasma display panel shown in FIG. 1 over which the discharge electrodes 120 are arranged. Referring to FIG. 3, the discharge electrodes 120 are arranged on the double barrier ribs 186 and 188. More specifically, the bus electrodes 121 are arranged on the double barrier ribs 186 and 188. The discharge electrodes 120 include the transparent electrodes 123, which transmit light and are formed of an electrically conductive material such as indium tin oxide (ITO), and the bus electrodes 121, which are formed of a highly electrically conductive metal.

The discharge electrodes 120 are arranged over the discharge cells. However, since the bus electrodes 121 do not transmit light, they may be arranged over the double barrier ribs 186 and 188 in order to improve the aperture ratio. The bus electrodes 121 comprise a plurality of lines that are arranged parallel to one another. Accordingly, the bus electrodes 121 may be arranged over the respective first double barrier ribs 186 and the respective second double barrier ribs 188. Here, since the bus electrodes 121 are linear, the single barrier ribs 184 are not covered with the bus electrodes 121. Thus, the bus electrodes 121 are arranged over the first or second double barrier ribs 186 or 188 and over the green discharge cells 190G defined by the single barrier ribs 184.

Portions of the discharge electrodes 120 exposed to the green discharge cells 190G are wider than those of the discharge electrodes 120 exposed to the red discharge cells 190R or the blue discharge cells 190B, so that discharge is generated more easily in the green discharge cells 190G than the discharge cells 190R and 190B.

The discharge electrodes 120 in the present embodiment may have a XX-YY electrode configuration.

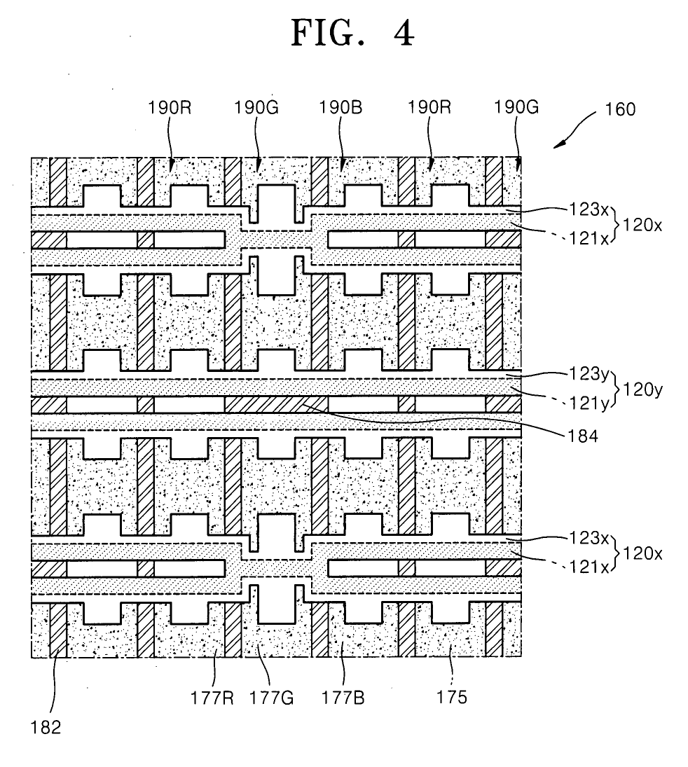

FIG. 4 is a plan view of a lower panel of a plasma display panel over which discharge electrodes are arranged, according to another embodiment. In this embodiment, another pattern of discharge electrodes is arranged over the lower panel 160, shown in FIG. 3, of the plasma display panel including the horizontal ribs 185 made up of the single barrier ribs 184 and the double barrier ribs 186 and 188. Hence, the lower panel of the present embodiment is the same as that shown in FIG. 3, so it will not be described again and differences between the previous and present embodiments will be focused on.

Referring to FIG. 4, discharge electrodes 120 include X electrodes 120x and Y electrodes 120y. The X electrodes 120x include X bus electrodes 121x and X transparent electrodes 123x, and the Y electrodes 120y include Y bus electrodes 121y and Y transparent electrodes 123y.

Adjacent X electrodes 120x are integrally formed into a single body so that the adjacent X electrodes 120x can apply a common voltage to the discharge cells of a previous discharge cell row and the discharge cells of a current discharge cell row. However, adjacent Y electrodes 120y are formed separately from each other so that the adjacent Y electrodes 120y can apply different voltages to the discharge cells of a previous discharge cell row and the discharge cells of a current discharge cell row. Hence, the X electrodes 120x have the same pattern as the horizontal ribs 185 made up of both the single barrier ribs 184 and the double barrier ribs 186 and 188. However, the Y electrodes 120y are arranged in line shapes over the double barrier ribs 186 and 188 so that the single barrier ribs 184 are exposed between the Y electrodes 120y. In other words, the Y electrodes 120y have the same shape as the discharge electrodes 120 of the previous embodiment illustrated in FIG. 3.

The X bus electrodes 121x are arranged over the single barrier ribs 184 and the double barrier ribs 186 and 188, and not over the non-discharge areas defined by the double barrier ribs 186 and 188. Accordingly, each of the X bus electrodes 121x can have the shape of an array of tuning forks.

The X transparent electrodes 123x may be formed in contact with the X bus electrodes 121x so as to be wide. More specifically, the X transparent electrodes 123x include extensions that contact the X bus electrodes 121x and have the same pattern as the X bus electrodes 121x, and protrusions that protrude from the extensions toward upper areas of the discharge cells.

In this embodiment, the extensions of the X transparent electrodes 123x have the same pattern as the X bus electrodes 121x and the protrusions of the X transparent electrodes 123x protrude from the extensions to over the discharge cells. However, the present embodiments are not limited to this structure. For example, the X transparent electrodes 123x may be not only arranged over the single barrier ribs 184 and the double barrier ribs 186 and 188 but also arranged over the non-discharge areas, which is different from the arrangement of the X bus electrodes 121x.

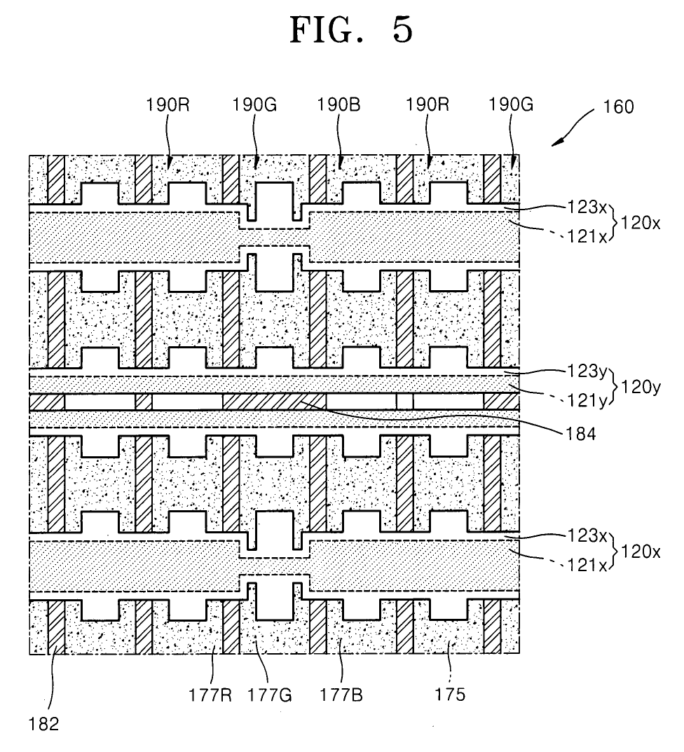

FIG. 5 is a plan view of a lower panel of a plasma display panel over which discharge electrodes are arranged, according to another embodiment. In this embodiment, another pattern of discharge electrodes is arranged over the lower panel 160 shown in FIG. 3 of the plasma display panel including the horizontal ribs 185 made up of the single barrier ribs 184 and the double barrier ribs 186 and 188. Hence, the lower panel of the present embodiment is the same as that shown in FIG. 3, so it will not be described again and differences between the previous and present embodiments will be focused on.

Referring to FIG. 5, the discharge electrodes 120 include, like the discharge electrodes 120 shown in FIG. 4, X electrodes 120x and Y electrodes 120y. The X electrodes 120x include X bus electrodes 121x and X transparent electrodes 123x, and the Y electrodes 120y include Y bus electrodes 121y and Y transparent electrode 123y. Adjacent X electrodes 120x are integrally formed into a single body so as to apply a common voltage to the discharge cells of a previous discharge cell row and the discharge cells of a current discharge cell row. However, adjacent Y electrodes 120y are formed separately from each other so as to apply different voltages to the discharge cells of a previous discharge cell row and the discharge cells of a current discharge cell row at different times.

The Y bus electrodes 121y are straight lines arranged in parallel over the double barrier ribs 186 and 188. Extensions of the Y transparent electrodes 123y are formed in contact with the Y bus electrodes 121y so as to have straight-line shapes, and protrusions of the Y transparent electrodes 123y protrude from the extensions toward over the discharge cells.

The X bus electrodes 121x are formed to cover the single barrier ribs 184, the double barrier ribs 186, 188, and the non-discharge area. Hence, the X bus electrodes 121x have hammer shapes in which a first area of the X bus electrode 121x that is disposed over the single barrier ribs 184 is narrower than a second area of the X bus electrode 121x that is disposed over the double barrier ribs 186, 188 and the non-discharge area. Extensions of the X transparent electrodes 123x have the same pattern as the X bus electrodes 121x, and protrusions of the X transparent electrodes 123x protrude from the extensions toward over the discharge cells.

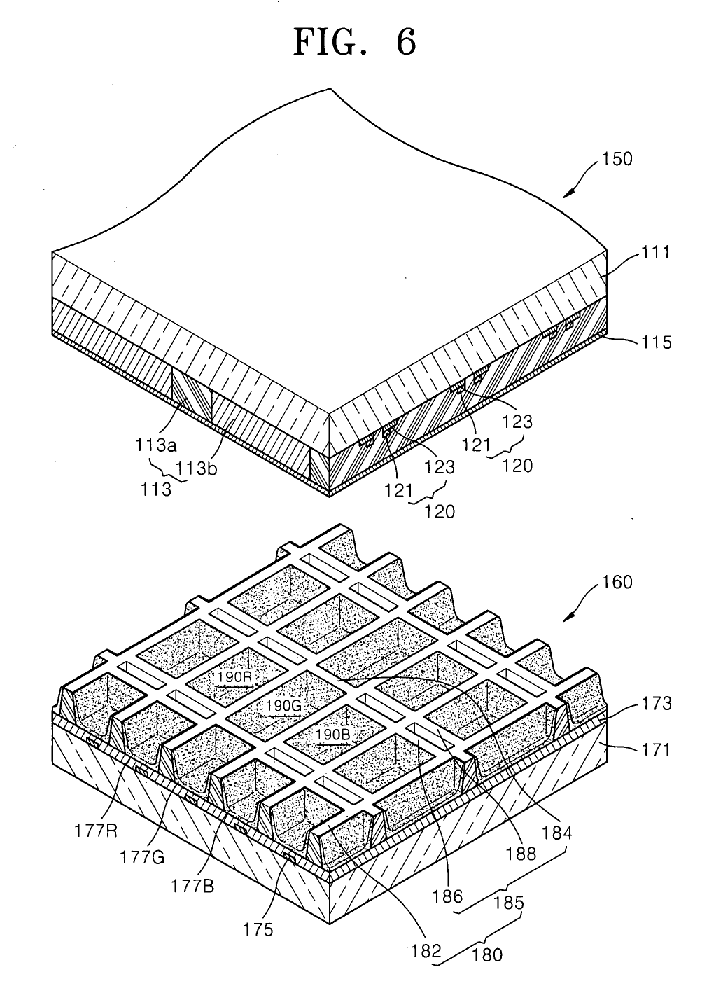

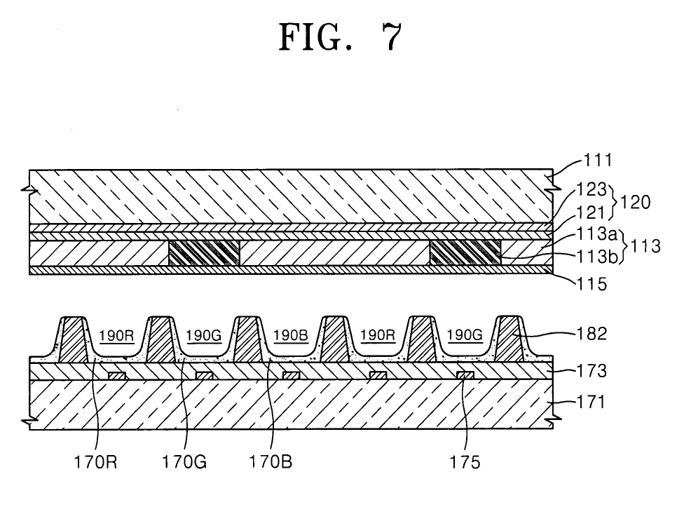

FIG. 6 is an exploded perspective view of a plasma display panel according to another embodiment. FIG. 7 is a cross-section of the plasma display panel shown in FIG. 6.

Referring to FIGS. 6 and 7, the plasma display panel includes an upper panel 150 and a lower panel 160.

The upper panel 150 includes an upper substrate 111, a plurality of discharge electrodes 120 arranged parallel to one another on the upper substrate 111, and an upper dielectric layer 113 formed on the upper substrate 111 and covering the discharge electrodes 120. A protection layer 115 is formed on the upper dielectric layer 113.

The lower panel 160 includes a plurality of address electrodes 175 arranged on a lower substrate 171 and intersecting the discharge electrodes 120, a lower dielectric layer 173 formed on the lower substrate 171 and covering the address electrodes 175, and a barrier structure 180 defining a plurality of discharge cells on the lower dielectric layer 173. Phosphor layers 177R, 177G, and 177B are coated within the discharge cells, and a discharge gas is injected into the discharge cells having the phosphor layers 177R, 177G, and 177B coated therewithin.

The barrier structure 180 includes vertical ribs 182 parallel to the address electrodes 175, and horizontal ribs 185 intersecting the vertical ribs 182. The horizontal ribs 185 include single barrier ribs 184 and double barrier ribs 186 and 188.

The discharge cells are defined by the barrier structure 180. The single barrier ribs 184 define green discharge cells 190G, and the double barrier ribs 186 and 188 define red discharge cells 190R and blue discharge cells 190B. Accordingly, the green discharge cells 190G have wider discharge spaces than the red discharge cells 190G and the blue discharge cells 190B, and areas of the discharge electrodes that are exposed over the green discharge cells 190G are wider than those of the discharge electrodes that are exposed over the red and blue discharge cells 190R and 190B.

As the exposed areas of the discharge electrodes over the discharge cells increase, it becomes easier to induce wall charges. In addition, a wide discharge space is ensured, leading to a decrease in the distortion of a discharge field. Thus, a discharge initiation voltage is reduced, and discharge can be made relatively more easily. Furthermore, a discharge voltage is also decreased, leading to non-uniformity between discharges generated in discharge cells.

In the present embodiment, the upper dielectric layer 113 includes first upper dielectric layers 113a and second upper dielectric layers 113b that have different dielectric constants. To prevent the discharge non-uniformity between discharge cells, the second upper dielectric layers 113b having a higher dielectric constant are arranged over the relatively wide green discharge cells 190G, and the first upper dielectric layers 113a having a lower dielectric constant are arranged over the red and blue discharge cells 190R and 190B.

A dielectric layer can serve as a capacitive load. Accordingly, when the dielectric constant of the dielectric layer is increased according to Equation 1, the capacitance increases and accordingly the load increases, thereby preventing discharge:

$$C = ɛ \frac{A}{d} \qquad ( 1 )$$

wherein C denotes a capacitance, ε denotes a dielectric constant, A denotes the size of an electrode, and d denotes a distance between electrodes.

Therefore, discharge is more easily generated within the green discharge cells 190G defined by the single barrier ribs 184 than within the other discharge cells. This discharge non-uniformity between discharge cells can be prevented by increasing the dielectric constant of the second upper dielectric layers 113b over the green discharge cells 190G to increase the capacitive load.

The upper substrate 111, the discharge electrodes 120, the protection layer 115, the lower substrate 171, the address electrodes 175, and the lower dielectric layer 173 are the same as those described above with reference to FIG. 1, so a description thereof will be omitted.

As described above, a plasma display panel including barrier ribs in which single barrier ribs are mixed with double barrier ribs, according to the present embodiments, increases a 1% peak brightness and a full white brightness, thereby minimizing the power consumption and maximizing the brightness.

In addition, bus electrodes are formed on the barrier ribs in which the single barrier ribs and the double barrier ribs are mixed, so that the aperture ratio of the plasma display panel can be increased. Thus, the plasma display panel provides improved luminous efficiency.

Moreover, since the plasma display panel according to the present embodiments includes barrier ribs in which the single barrier ribs are mixed with the double barrier ribs, the discharge spaces of the discharge cells defined by the single barrier ribs are wide compared with those of the discharge cells of a conventional plasma display panel, and areas of the discharge electrodes that are exposed to the discharge cells increase compared with the conventional plasma display panel. Thus, a discharge is more easily generated. Also, in the plasma display panel according to the present embodiments, upper dielectric layers having a high dielectric constant are arranged on the discharge cells defined by the single barrier ribs, so that the capacitive load of the upper dielectric layers is increased. Thus, discharge non-uniformity between discharge cells can be prevented.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a front substrate and a rear substrate arranged to face each other;
a plurality of horizontal ribs defining a discharge space between the front and rear substrates, wherein the horizontal ribs comprise single barrier ribs and double barrier ribs;
a plurality of vertical ribs arranged perpendicularly to the horizontal ribs configured to define a plurality of discharge cells; and
a plurality of pairs of discharge electrodes to which a voltage is applied so that a discharge is generated within the discharge cells.

2. The plasma display panel of claim 1, wherein the discharge cells comprise first discharge cells and second discharge cells wider than the first discharge cells.

3. The plasma display panel of claim 2, wherein the horizontal ribs that define the first discharge cells are double barrier ribs, and the horizontal ribs defining the second discharge cells are single barrier ribs.

4. The plasma display panel of claim 1, wherein:
the horizontal ribs are parallel to one another; and
at least one of the horizontal ribs comprises double barrier ribs and single barrier ribs.

5. The plasma display panel of claim 4, wherein the discharge cells comprise first discharge cells and second discharge cells that have higher brightness than the first discharge cells.

6. The plasma display panel of claim 5, wherein the horizontal ribs that define the first discharge cells are double barrier ribs, and the horizontal ribs defining the second discharge cells are single barrier ribs.

7. The plasma display panel of claim 1, wherein:
the discharge cells comprise red discharge cells, green discharge cells, and blue discharge cells; and
the horizontal ribs defining the green discharge cells are the single barrier ribs.

8. The plasma display panel of claim 1, wherein:
the discharge electrodes comprise transparent electrodes and bus electrodes; and
the bus electrodes are arranged over the double barrier ribs.

9. The plasma display panel of claim 8, wherein the bus electrodes are arranged over the double barrier ribs but not over the single barrier ribs.

10. The plasma display panel of claim 8, wherein:
the discharge cells comprise the red discharge cells, the green discharge cells, and the blue discharge cells;
the horizontal ribs defining the green discharge cells are the single barrier ribs; and
the bus electrodes are arranged over the double barrier ribs and the green discharge cells.

11. The plasma display panel of claim 1, wherein:
the discharge electrodes comprise X electrodes and Y electrodes;
the X electrodes comprise X transparent electrodes and X bus electrodes; and
the X bus electrodes are arranged over the double barrier ribs and single barrier ribs of the horizontal ribs.

12. The plasma display panel of claim 11, wherein the X bus electrodes are arranged over the double barrier ribs and the single barrier ribs of the horizontal ribs but not over non-discharge areas defined by the double barrier ribs.

13. The plasma display panel of claim 1, wherein:
the discharge electrodes comprise X electrodes and Y electrodes;
the X electrodes comprise X transparent electrodes and X bus electrodes; and
the X bus electrodes are arranged over the double barrier ribs and single barrier ribs of the horizontal ribs and the non-discharge areas defined by the double barrier ribs.

14. The plasma display panel of claim 13, wherein the X bus electrodes comprise first areas arranged over the single barrier ribs and second areas arranged over the double barrier ribs and the non-discharge areas so as to have a greater width than the first areas.

15. The plasma display panel of claim 1, further comprising an upper dielectric layer formed on the front substrate and comprising first upper dielectric layers and second upper dielectric layers that have different dielectric constants.

16. The plasma display panel of claim 15, wherein:
the discharge cells comprise first discharge cells and second discharge cells wider than the first discharge cells;
the horizontal ribs that define the first discharge cells are double barrier ribs; and
the horizontal ribs defining the second discharge cells are single barrier ribs.

17. The plasma display panel of claim 16, wherein:
the second upper dielectric layers have a higher dielectric constant than the first upper dielectric layers; and
the second upper dielectric layers are arranged over the second discharge cells.

18. The plasma display panel of claim 15, wherein:
the discharge cells comprise the red discharge cells, the green discharge cells, and the blue discharge cells;
the second upper dielectric layers have a higher dielectric constant than the first upper dielectric layers; and
the second upper dielectric layers are arranged over the green discharge cells.
